(19) United States
(12) Patent Application Publication
(10) Pub. No.: US 2016/0125136 A1
(43) Pub. Date: May 5, 2016

(54) A SYSTEM AND METHOD FOR REAL TIME ANALYSIS OF MEDICAL IMAGING

(71) Applicant: MEDYMATCH TECHNOLOGY LTD., Tel Aviv (IL)

(72) Inventor: Netanel PERI, Tel Aviv (IL)

(73) Assignee: MEDYMATCH TECHNOLOGY LTD., Tel Aviv (IL)

(21) Appl. No.: 14/894,354

(22) PCT Filed: May 25, 2014
(86) PCT No.: PCT/IL2014/050467

§ 371 Date: Nov. 26, 2015

Related U.S. Application Data
(60) Provisional application No. 61/835,650, filed on Jun. 17, 2013.

(51) Int. Cl. G06F 19/00; G06F 17/30

(52) U.S. Cl. CPC G06F 19/321; G06F 17/30265

(57) ABSTRACT

A system for real-time analyzing of medical imaging comprising: (a) a data base of images and text associated with at least one of the images; the images are of medical imaging; (b) a first computer readable medium (FCRM) having instructions thereon for: (i) receiving an image from a picture archiving and communication system (PACS); (ii) communicating with the data base; and (iii) comparing between the image and the database of images; and (c) a second computer readable medium (SCRM) is in communication with the FCRM; wherein the FCRM is further instructed to find related images and text from the data base; further wherein the FCRM is instructed to send the related images and text to SCRM in real-time.

### FIELD OF THE INVENTION

The current invention relates to the field of medical imaging. More specifically, to the field of analyzing results of medical imaging.

### BACKGROUND

Medical imaging has been a major tool in medicine for many years now. Although our abilities to image the inside of a subject have improved significantly during the years, the field of analyzing the results of this imaging was left behind.

Today, most of the analysis is based on looking at the results and analyzing them only by look and experience. The analysis is primarily done on a visual basis and does not rely on textual BIG DATA.

In addition, in the last few years, the field of BIG DATA has evolved, supplying the medical community with new opportunities for improvement.

There is therefore a long unmet need for a system that will integrate the visual abilities of the medical imaging devices with the source of data supplied by BIG DATA field.

### BRIEF DESCRIPTION OF THE INVENTION

A system for real-time analyzing of medical imaging comprising:

a. a data base of images and text associated with at least one of said images; said images are of medical imaging;

b. a first computer readable medium (FCRM) having instructions thereon for:
(i) receiving an image from a picture archiving and communication system (PACS);
(ii) communicating with said data base;
(iii) comparing between said image and said database of images;

c. a second computer readable medium (SCRM) is in communication with said FCRM
wherein said FCRM is further instructed to find related images and text from said data base; further wherein said FCRM is instructed to send said related images and text to SCRM in real-time.

In one embodiment of the current invention, the system as described above, wherein the device is selected from a group consisting of: MRI, CT, ultrasound, X-ray, and any other medical device.

In one embodiment of the current invention, the system as described above, wherein the system is used during an operation.

In one embodiment of the current invention, the system as described above, wherein the related images and text are sent to an application on a mobile device of the SCRM.

In one embodiment of the current invention, the system as described above, wherein the related images and text are sent to the device.

In one embodiment of the current invention, the system as described above, wherein the related images and text are sent to a designated device communicating with the SCRM.

In one embodiment of the current invention, the system as described above, wherein the either one of the FCRM, the database are located on a cloud-base service.

In one embodiment of the current invention, the system as described above, wherein the finding of the related images and text is done according to parameters of the subject selected from a group consisting of: age, sex, gender, weight, height, medical history, family medical history, genetic profile, medical data, individual risk factors, prescribed medication, and a combination thereof.

In one embodiment of the current invention, the system as described above, wherein the instructions are further for giving information to the SCRM regarding further imaging of the subject.

In one embodiment of the current invention, the system as described above, wherein the FCRM is further adapted for improving the finding according to feedback from the SCRM.

The system according to claim 1, wherein the FCRM if further in communication with other databases of images and text.

In one embodiment of the current invention, the system as described above, wherein the FCRM sends medical recommendation to the SCRM in real time.

In one embodiment of the current invention, the system as described above, wherein the database is in communication with a second database of medical literature used to detect relevant data to send to the SCRM.

In one embodiment of the current invention, the system as described above, wherein the FCRM are in communication with software related to the imaging device; the software is used to find the related data and images.
In one embodiment of the current invention, the system as described above, wherein the SCRM receives a second feedback according to the feedback from the FCRM.
In one embodiment of the current invention, the system as described above, wherein the FCRM sends to said SCRM statistical analysis regarding the feedback.
In one embodiment of the current invention, the system as described above, wherein the SCRM creates a time line of analysis of the image.

A method for real-time analyzing of medical imaging comprising steps of:

a. providing a data base of images and text associated with at least one of said images; said images are of medical imaging;

b. receiving in a computer readable medium (CRM) a first image from a picture archiving and communication system (PACS);

c. communicating between said FCRM and said data base;

d. comparing between said image and said database of images;

wherein said method additionally comprising steps of:

e. finding related images and text from said data base; and

a. F. sending said related images and text to device second computer readable medium (SCRM) in real time.

In one embodiment of the current invention, the method as described above, wherein the device is selected from a group consisting of: MRI, CT, ultrasound, X-ray, and any other medical device.

In one embodiment of the current invention, the method as described above, wherein the system is used during an operation.

In one embodiment of the current invention, the method as described above, additionally comprising step of sending the related images and text to an application on a mobile device of the SCRM.

In one embodiment of the current invention, the method as described above, additionally comprising step of sending the related images and text to the device.

In one embodiment of the current invention, the method as described above, additionally comprising step of sending the related images and text to a designated device communicating with the SCRM.

In one embodiment of the current invention, the method as described above, wherein the either one of the FCRM, the database are located on a cloud-base service.

In one embodiment of the current invention, the method as described above, wherein the finding of the related images and text is done according to parameters of the subject selected from a group consisting of: age, sex, gender, weight, height, medical history, family medical history, genetic profile, medical data, individual risk factors, prescribed medication, and a combination thereof.

In one embodiment of the current invention, the method as described above, additionally comprising step of giving information to the SCRM regarding further imaging of the subject.

In one embodiment of the current invention, the method as described above, additionally comprising step of improving the finding according to feedback received from the SCRM. Improving can be done by machine learning methods. And by fine tuning of previous feedback stored in the application.

In one embodiment of the current invention, the method as described above, additionally comprising step of communicating between the FCRM, and other databases of images and text.

In one embodiment of the current invention, the method as described above, additionally comprising step of sending medical recommendation and decision support system, tools and features, to the SCRM in real time and on “Any glass” using the FCRM.

In one embodiment of the current invention, the method as described above, additionally comprising step of communicating between the database and a second database of medical literature and other EMRs (Electronic Medical record) used to detect relevant data to send to the SCRM.

In one embodiment of the current invention, the method as described above, additionally comprising step of communicating between the FCRM and software related to the imaging device; the software is used to find the related data and images.
In one embodiment of the current invention, the method as described above, wherein the SCRM receives a second feedback according to the feedback from the FCRM.
In one embodiment of the current invention, the method as described above, wherein the FCRM sends to said SCRM statistical analysis regarding the feedbacks.
In one embodiment of the current invention, the method as described above, wherein the SCRM creates a time line of analyses of the image.

### BRIEF DESCRIPTION OF THE DRAWINGS

In order to understand the invention and to see how it may be implemented in practice, a few preferred embodiments will now be described, by way of non-limiting example only, with reference to be accompanying drawings, in which:

FIG. 1 describes a system for designing of system for real-time analyzing of medical imaging;

FIG. 2 discloses a flow chart for a method of system for real-time analyzing of medical imaging.

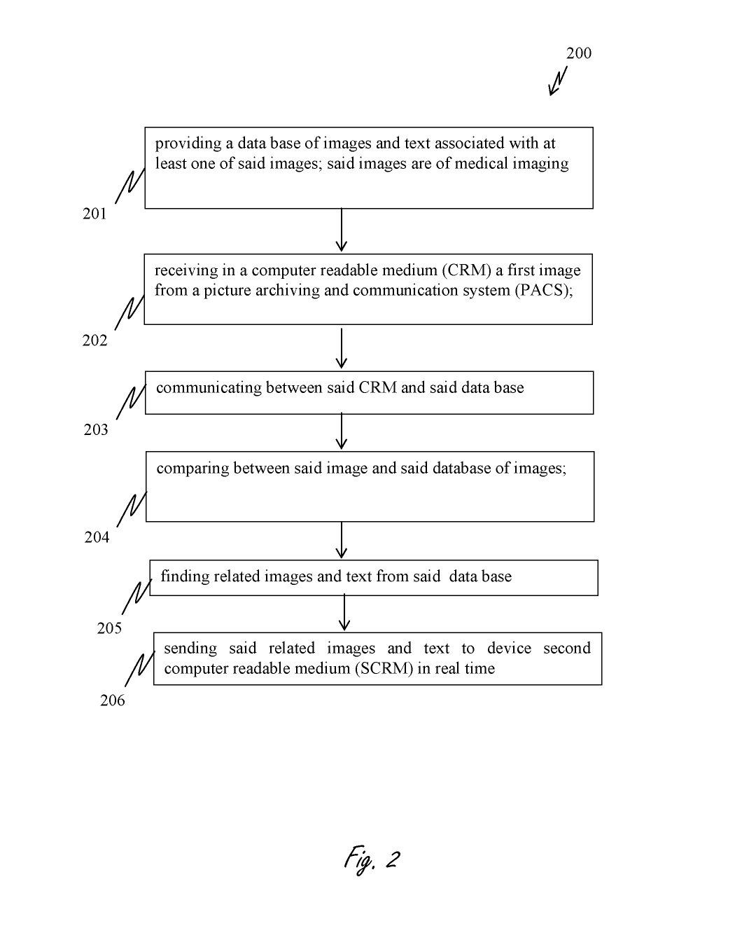

### DETAILED DESCRIPTION OF THE INVENTION

The following description is provided so as to enable any person skilled in the art to make use of the invention and sets forth examples contemplated by the inventor of carrying out this invention. Various modifications, however, will remain apparent to those skilled in the art, since the generic principles of the present invention have been defined specifically. Also, it is to be understood that the phraseology and terminology employed herein is for the purpose of description and should not be regarded as limiting.

It is one object of the current invention to provide a

A system for real-time analyzing of medical imaging comprising:

a. a data base of images and text associated with at least one of said images; said images are of medical imaging;

b. a first computer readable medium (FCRM) having instructions thereon for:
(iv) receiving an image from a picture archiving and communication system (PACS);
(v) communicating with said data base;
(vi) comparing between said image and said database of images;

c. a second computer readable medium (SCRM) is in communication with said FCRM

wherein said FCRM is further instructed to find related images and text from said data base; further wherein said FCRM is instructed to send said related images and text to SCRM in real-time

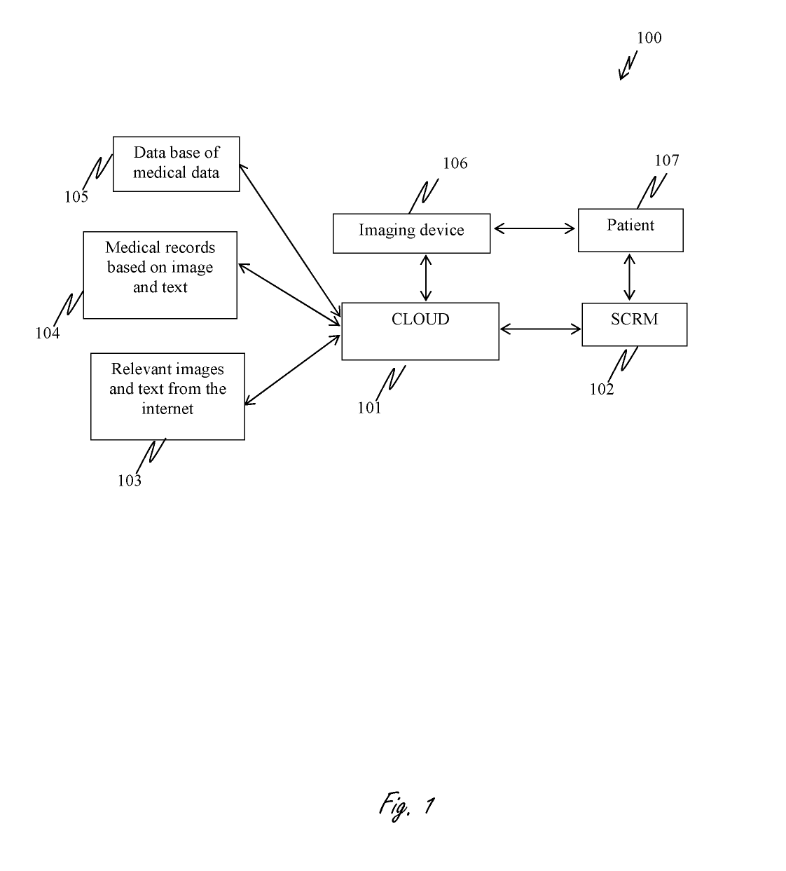

Reference is now made to FIG. 1 illustrating one embodiment of the current invention of a system 100 comprising: a loud server 101 communicating with an imaging device 106 that scans a patient 107. The scanning image of the patient 107 is sent back to the cloud server 101 for analysis. The analysis is done by communicating between the cloud server 101 and different databases (e.g. database of medical data 105, medical records based on image and text 104, relevant images and text from the internet 103). The cloud server 101 searches these databases for best match with the scanning he received from the imaging device 106. Once a match was found, the server 101 sends this data to the SCRM 102 which may be a mobile device belonging to a doctor treating the patient 107. This can be done with an additional medical recommendation for further treatment.

In one embodiment of the current invention, the system as described above, wherein the device is selected from a group consisting of: MRI, CT, ultrasound, X-ray, and any other medical device.

In one embodiment of the current invention, the system as described above, wherein the system is used during an operation.

In one embodiment of the current invention, the system as described above, wherein the related images and text are sent to an application on a mobile device of the SCRM.

In one embodiment of the current invention, the system as described above, wherein the related images and text are sent to the device.

In one embodiment of the current invention, the system as described above, wherein the related images and text are sent to a designated device communicating with the SCRM.

In one embodiment of the current invention, the system as described above, wherein the either one of the FCRM, the database are located on a cloud-base service.

In one embodiment of the current invention, the system as described above, wherein the finding of the related images and text is done according to parameters of the subject selected from a group consisting of: age, sex, gender, weight, height, medical history, family medical history, genetic profile, medical data, individual risk factors, prescribed medication, and a combination thereof.

In one embodiment of the current invention, the system as described above, wherein the instructions are further for giving information to the SCRM regarding further imaging of the subject.

In one embodiment of the current invention, the system as described above, wherein the FCRM is further adapted for improving the finding according to feedback from the SCRM.

The system according to claim 1, wherein the FCRM if further in communication with other databases of images and text.

In one embodiment of the current invention, the system as described above, wherein the FCRM sends medical recommendation to the SCRM in real time.

In one embodiment of the current invention, the system as described above, wherein the database is in communication with a second database of medical literature used to detect relevant data to send to the SCRM.

In one embodiment of the current invention, the system as described above, wherein the FCRM are in communication with software related to the imaging device; the software is used to find the related data and images.
In one embodiment of the current invention, the system as described above, wherein the SCRM receives a second feedback according to the feedback from the FCRM.
In one embodiment of the current invention, the system as described above, wherein the FCRM sends to said SCRM statistical analysis regarding the feedback to the expert iPad.
In one embodiment of the current invention, the system as described above, wherein the SCRM creates a time line of analysis of the image.

Reference is now made to FIG. 1 illustrating in a non-limiting manner one embodiment of the current invention of

A method for real-time analyzing of medical imaging comprising steps of:
Step 201 of providing a data base of images and text associated with at least one of said images; said images are of medical imaging;
Step 202 of receiving in a computer readable medium (CRM) a first image from a picture archiving and communication system (PACS);
Step 203 of communicating between said FCRM and said data base;
Step 204 of comparing between said image and said database of images;

wherein said method additionally comprising steps of:
step 205 of finding related images and text from said data base; and
step 206 sending said related images and text to device second computer readable medium (SCRM) in real time

In one embodiment of the current invention, the method as described above, wherein the device is selected from a group consisting of: MRI, CT, ultrasound, X-ray, and any other medical device.

In one embodiment of the current invention, the method as described above, wherein the system is used during an operation.

In one embodiment of the current invention, the method as described above, additionally comprising step of sending the related images and text to an application on a mobile device of the SCRM.

In one embodiment of the current invention, the method as described above, additionally comprising step of sending the related images and text to the device.

In one embodiment of the current invention, the method as described above, additionally comprising step of sending the related images and text to a designated device communicating with the SCRM.

In one embodiment of the current invention, the method as described above, wherein the either one of the FCRM, the database are located on a cloud-base service.

In one embodiment of the current invention, the method as described above, wherein the finding of the related images and text is done according to parameters of the subject selected from a group consisting of: age, sex, gender, weight, height, medical history, family medical history, genetic profile, medical data, individual risk factors, prescribed medication, and a combination thereof.

In one embodiment of the current invention, the method as described above, additionally comprising step of giving information to the SCRM regarding further imaging of the subject.

In one embodiment of the current invention, the method as described above, additionally comprising step of improving the finding according to feedback received from the SCRM.

In one embodiment of the current invention, the method as described above, additionally comprising step of communicating between the FCRM, and other databases of images and text.

In one embodiment of the current invention, the method as described above, additionally comprising step of sending medical recommendation to the SCRM in real time using the FCRM.

In one embodiment of the current invention, the method as described above, additionally comprising step of communicating between the database and a second database of medical literature used to detect relevant data to send to the SCRM.

In one embodiment of the current invention, the method as described above, additionally comprising step of communicating between the FCRM and software related to the imaging device; the software is used to find the related data and images.
In one embodiment of the current invention, the method as described above, wherein the SCRM receives a second feedback according to the feedback from the FCRM, he and other experts have provided to the FCRM.
In one embodiment of the current invention, the method as described above, wherein the FCRM sends to said SCRM statistical analysis regarding the feedback.
In one embodiment of the current invention, the method as described above, wherein the SCRM creates a time line of analysis of the imaging, then, no information regarding the image's diagnosis will lose during the treatment workflow”.

This time line can be used for the physician to measure his performance quality, by the statics of success that will be provided to him during the time line of the imaging pop up, and enhance his personal skills.

Also, in other embodiment of the current invention correlation between the common biases\mistakes, of group of radiologists\physicians by data mining, will be provided, therefore, enhancing the training process at medical schools.

We can also enhance the communication between the referring physicians to the radiologist\expert, and be sure that the information workflow, functioning well.

### EXAMPLE 1

In one example of the current invention, a person is doing an ultra-sound. The operator of the ultra sound is connecting with the ultra sound device to a data base. The database has both images of previous ultrasounds and text related to these images. The data base scan its images to find a compatible image to the image being taken of the person. Once an image and text are found, they are being sent back to the operator. The operator can use the image and text in order to diagnose the patient or to re-focus his scanning with the ultra sound.

### EXAMPLE 2

In another example of the current invention, a surgeon is doing an operation, during this operation he is using s medical imaging device which is in communication with a database. The surgeon is putting into the system the parameters of his patient: female 70 Kg 173 cm and genetic profile. The system is able to detect another imaging similar to the imaging produced during the operation, of a female with parameters of: 170 cm 65 kg and similar genetic profile. The system then sends the surgeon the result of this imaging and the surgeon uses the data in order to decide how to proceed in the operation.

### EXAMPLE 3

In another example of the current invention, an imaging device is communicating with software that is doing an internet search through a server. The software provides data of images and text from the internet related to the image which was scanned in the imaging device. The data extracted from the internet and other EMRs is being narrowed by comparing it to data from a database of medical imaging (including text) in the server. At the end of the process, the system can detect a similar scanning and provide medical advice according to medical history records also communicating with the server. This medical advice can be sent back to the imaging device or to an application installed on the mobile device of either the doctor or the patient.

### EXAMPLE 4

A data base of images and text is located on a cloud service together with an application adapted for analyzing and comparing images. A medical image is sent to this application from a PACS system in a hospital. The imaging is of CT brain. The application scans the image and compares it with other images in the data base. Once the application finds in the database a similar image, the application uses the text attached to this image to send a doctor a possible diagnosis. The doctor receive this diagnosis together with a confidence level directly to his iPAD. The ROI (region of interests) and segments, mark or highlight, by unique signs and colors that the FCRM provides, and the physician type on the iPad if he agree or disagree or other feedback, regard the, marks, signs and highlight's ROI.

### EXAMPLE 5

In another example of the current invention, an application for image analysis is installed on a PACS system in a hospital, in a cloud server, and in an application of a doctor's mobile device. The three applications communicate with one another. An image is taken in a CT device and being processed in the PACS server, after initial analysis it is being sent to the cloud, and there matching to other images is performed. After the matching a diagnosis is established which is being sent directly to the doctor's mobile device. The doctor estimate the quality of the diagnosis and sends a feedback back to the cloud, this feedback is stored for future reference.

This feedback can be for example in the form: a. “Agreement” b. “Disagreement” c. “Other”

After some time a medical procedure may take place, the results of this medical procedures may be sent to cloud and from there to the doctor, giving both a feedback of the initial diagnosis. In addition, this feedback is used by the application to improve its future diagnosis.

It will be appreciated by persons skilled in the art that embodiment of the invention are not limited by what has been particularly shown and described hereinabove. Rather the scope of at least one embodiment of the invention is defined by the claims below.

1-36. (canceled)

37. A system for real-time analyzing of medical imaging comprising:
a. a data base of images and text associated with at least one of said images; said images are of medical imaging;
b. a first computer readable medium (FCRM) having instructions thereon for:
(i) receiving an image from a picture archiving and communication system (PACS) or EMR (Electronic Medical record);
(ii) communicating with said data base;
(iii) comparing between said image and said database of images;
c. a second computer readable medium (SCRM) is in communication with said FCRM
wherein said FCRM is further instructed to find related images and text from said data base; further wherein said FCRM is instructed to send said related images and text to SCRM in real-time.

38. The system according to claim 37, wherein said device is selected from a group consisting of: MRI, CT, ultrasound, X-ray, and any other medical device.

39. The system according to claim 37, wherein said related images and text are sent to at least one of:
a. an application on a mobile device of an expert.
b. a designated device communicating with said SCRM.

40. The system according to claim 37, wherein said finding of said related images and text is done according to parameters of said subject selected from a group consisting of: age, sex, gender, weight, height, medical history, family medical history, genetic profile, medical data, individual risk factors, prescribed medication, and a combination thereof.

41. The system according to claim 37, wherein said instructions are further for giving information to said SCRM of said device regarding further imaging of said subject.

42. The system according to claim 37, wherein said FCRM is further adapted for improving said findings according to feedback from said SCRM.

43. The system according to claim 37, wherein said FCRM if further adapted to perform at least one of the following:
a. communication with other databases of EMRs images and text.
b. sends medical recommendation to said SCRM in real time.
c. communication with software related to said imaging device; said software is used to find said related data and images.
d. comprising instructions for analyzing and diagnosing said image.

44. The system according to claim 37, wherein said database is in communication with a second database of medical literature used to detect relevant data to send to said SCRM.

45. The system according to claim 42, wherein one of the following is held true:
a. said SCRM receives a second feedback according to said feedback from said FCRM.
b. said FCRM sends to said SCRM statistical analysis regarding said feedback.
c. said SCRM creates a time line of analysis of said image.

46. A method for real-time analyzing of medical imaging comprising steps of:
a. providing a data base of images and text associated with at least one of said images; said images are of medical imaging;
b. receiving in a first computer readable medium (FCRM) a first image from a picture archiving and communication system (PACS) or EMR (Electronic Medical record);
c. communicating between said FCRM and said data base;
d. comparing between said image and said database of images;
wherein said method additionally comprising steps of:
e. finding related images and text from said data base; and
f. sending said related images and text to device second computer readable medium (SCRM) in real time.

47. The method according to claim 46, wherein said device is selected from a group consisting of: MRI, CT, ultrasound, X-ray, and any other medical device.

48. The method according to claim 46, wherein said system is used during an operation.

49. The method according to claim 46, additionally comprising step of sending said related images and text to an application on a said SCRM.

50. The method according to claim 46, additionally comprising step of sending said related images and text to a designated device communicating with said SCRM.

51. The method according to claim 46, wherein said finding of said related images and text is done according to parameters of said subject selected from a group consisting of: age, sex, gender, weight, height, medical history, family medical history, genetic profile, medical data, individual risk factors, prescribed medication, and a combination thereof.

52. The method according to claim 46, additionally comprising at least one step of following:
a. giving information to said SCRM regarding further imaging of said subject.
b. communicating between said FCRM and other databases of images and text.
c. comprising step of sending medical recommendation to said SCRM in real time using said FCRM, which included, ROI (region of interests) and segments, mark or highlight, by unique signs and colors that the FCRM provides.
d. communicating between said database and a second database of medical literature used to detect relevant data to send to said SCRM.
e. communicating between said FCRM and software related to said imaging device; said software is used to find said related data and images.

53. The method according to claim 46, additionally comprising step of improving said finding according to feedback received from said SCRM.

54. The method according to claim 46, wherein said FCRM additionally comprising instructions for analyzing and diagnosing said image.

55. The method according to claim 53, wherein said SCRM performs at least one of the following:
a. receiving a second feedback according to said feedback from said FCRM.
b. sending to said SCRM statistical analysis regarding said feedback.
c. creating a time line of analysis of said image.
